(19) United States
(12) Patent Application Publication
(10) Pub. No.: US 2024/0306716 A1
(43) Pub. Date: Sep. 19, 2024

(54) FLAVOR INHALER AND FLAVOR INHALING SYSTEM

(71) Applicant: Japan Tobacco Inc., Tokyo (JP)

(72) Inventors: Yasunobu INOUE, Tokyo (JP); Ryoji FUJITA, Tokyo (JP); Kazutoshi SERITA, Tokyo (JP); Sumie MIKAMI, Tokyo (JP)

(73) Assignee: Japan Tobacco Inc., Tokyo (JP)

(21) Appl. No.: 18/670,993

(22) Filed: May 22, 2024

Related U.S. Application Data
(63) Continuation of application No. PCT/JP2021/045066, filed on Dec. 8, 2021.

(51) Int. Cl. A24F 40/46; A24F 40/50

(52) U.S. Cl. CPC A24F 40/46; A24F 40/50

(57) ABSTRACT

A flavor inhaler that includes a heater comprising a plurality of heating elements and at least one first electrode, wherein the plurality of heating elements are stacked with the at least one first electrode interposed therebetween.

### CROSS-REFERENCE TO RELATED APPLICATION

The present invention contains subject matter related to PCT Application No. PCT/JP2021/045066 filed on Dec. 8, 2021, the entire contents of which are incorporated herein by reference.

### TECHNICAL FIELD

The present invention relates to a flavor inhaler and a flavor inhaling system.

### BACKGROUND ART

Known flavor inhalers are used for inhaling a flavor without burning a material. Various heaters used for such flavor inhalers have been proposed (see PTL 1). As one of such heaters, a heater in which a heating element and a conductive wire are stacked has been proposed (see PTL 2).

### CITATION LIST

### Patent Literature

PTL 1: Chinese Unexamined Utility Model Registration Application Publication No. 209807157
PTL 2: Chinese Unexamined Patent Application Publication No. 201810872487

### SUMMARY OF INVENTION

### Technical Problem

An object of the present invention is to provide a flavor inhaler and a flavor inhaling system including a heater with which heating can be more flexibly controlled.

### Solution to Problem

According to a first embodiment, a flavor inhaler is provided. This flavor inhaler includes a heater in which a plurality of heating elements are stacked with at least one first electrode interposed therebetween.

According to the first embodiment, heating can be more flexibly controlled by using the plurality of heating elements. Accordingly, release of a flavor component from the flavor inhaler can be more flexibly controlled.

The gist of a second embodiment is that, in the first embodiment, the plurality of heating elements include a first heating element and a second heating element, the first heating element, the second heating element, and the first electrode have respective planar shapes, and the first heating element and the second heating element are disposed so as to face each other with the first electrode interposed therebetween.

According to the second embodiment, the planar heater in which the first heating element, the first electrode, and the second heating element are stacked in this order can be provided. Accordingly, a compact structure is achieved, and a voltage can be efficiently applied.

The gist of a third embodiment is that, in the first or second embodiment, the flavor inhaler further includes a second electrode stacked outside an outermost heating element out of the plurality of heating elements. At least one of the first electrode and the second electrode includes a planar supporting member having conductivity.

According to the third embodiment, since the heater can be supported by the first electrode or the second electrode, a malfunction and destruction of the heater due to deformation can be suppressed. Furthermore, since the first electrode or the second electrode also serves as a supporting body, the heater and the flavor inhaler can have a compact structure. In addition, the flavor inhaler can be efficiently manufactured.

The gist of a fourth embodiment is that, in the third embodiment, the supporting member includes stainless steel.

According to the fourth embodiment, since stainless steel has high stiffness and high durability, a malfunction and destruction of the heater due to deformation can be further suppressed.

The gist of a fifth embodiment is that, in the third or fourth embodiment, in at least one electrode out of the first electrode and the second electrode, a connection electrode is formed along a plane in which an adjacent heating element adjacent to the at least one electrode extends, and the connection electrode protrudes in a longitudinal direction of the adjacent heating element from a range in which the adjacent heating element extends.

According to the fifth embodiment, electrical connection between the connection electrode and a circuit outside the heater is facilitated.

The gist of a sixth embodiment is that, in the fifth embodiment, the connection electrode has a connection portion at an end surface thereof or near the end surface thereof to be connected to an outer portion, and an insulation treatment is applied to a surface of the connection electrode other than the connection portion.

According to the sixth embodiment, shorting between connection electrodes and between the connection electrode and another electrode can be suppressed.

The gist of a seventh embodiment is that, in the fifth or sixth embodiment, no electrode other than the connection electrode protrudes from the range in which the adjacent heating element extends along the plane in which the adjacent heating element extends.

According to the seventh embodiment, shorting between the electrode other than the connection electrode and the other electrode can be suppressed.

The gist of an eighth embodiment is that, in the third to seventh embodiments, at least one electrode out of the first electrode and the second electrode includes a plurality of current-carrying regions, and the plurality of current-carrying regions are disposed so as to respectively face a plurality of heating portions of the heating element adjacent to the at least one electrode.

According to the eighth embodiment, heating of each of the plurality of heating portions of the heating element can be controlled, and accordingly, heating by using the heater can be still more flexibly controlled.

The gist of a ninth embodiment is that, in the first to eighth embodiments, the first electrode includes a thermally insulative material.

According to the ninth embodiment, thermal transmission between the plurality of heating elements can be suppressed, and accordingly, the temperature of each of the heating elements can be more accurately controlled. Furthermore, heat generated by the heating elements can be efficiently directed toward a consumer product.

The gist of a tenth embodiment is that, in the first to ninth embodiments, the flavor inhaler further includes a heating controller configured to control a voltage or a current applied to each of the plurality of heating elements.

According to the tenth embodiment, the plurality of heating elements can be more flexibly controlled.

The gist of an eleventh embodiment is that, in the tenth embodiment, the heating controller controls the voltage to heat a subset of the plurality of heating elements, and after that, heat at least a subset of the other heating elements.

According to the eleventh embodiment, the temperature of a flavor generating substrate heated by the heating element heated before the other increases quickly. This can reduce a time period from a time at which the flavor inhaler is started to a time at which a user of the flavor inhaler (hereinafter, simply referred to as the user) can inhale the flavor.

The gist of a twelfth embodiment is that, in the first to eleventh embodiments, the plurality of heating elements include a positive temperature coefficient (PTC) element.

According to the twelfth embodiment, due to the characteristic of the PTC element, the current is unlikely to flow through the PTC element when the temperature increases to the predetermined temperature. Accordingly, complex control is not necessary, and a safe flavor inhaler can be provided.

According to a thirteenth embodiment, a flavor inhaling system is provided. This flavor inhaling system includes a consumer product having a flavor component and the flavor inhaler according to any one of the first to twelfth embodiments.

According to the thirteenth embodiment, heating can be more flexibly controlled by using the plurality of heating elements. Accordingly, release of the flavor component from the flavor inhaling system can be more flexibly controlled.

The gist of a fourteenth embodiment is that, in the thirteenth embodiment, the consumer product includes a plurality of portions having identical or different flavor components disposed at positions respectively facing the plurality of heating elements when inhalation is performed.

According to the fourteenth embodiment, release of the flavor components can be more flexibly controlled. Furthermore, the flavor components can be disposed in the plurality of portions depending on a taste of the user, convenience, or the like.

### BRIEF DESCRIPTION OF DRAWINGS

FIG. 1 is a sectional view illustrating a main portion of a flavor inhaler according to an embodiment in a width direction of a heater.

FIG. 2 is a sectional view illustrating the main portion of the flavor inhaler according to the embodiment in a thickness direction of the heater.

FIG. 3 is a conceptual view illustrating the heater and a controller according to the present embodiment.

FIG. 4 is an exploded view schematically illustrating the structure of the heater according to the embodiment.

FIG. 5A is a plan view schematically illustrating the heater according to the embodiment.

FIG. 5B is a side view schematically illustrating the heater according to the embodiment.

FIG. 6A is a conceptual view illustrating a section taken along line A1-A1 of FIG. 5A

FIG. 6B is a conceptual view illustrating a section taken along line A2-A2 of FIG. 5A

FIG. 7A is a schematic side sectional view illustrating a consumer product according to the embodiment.

FIG. 7B is a conceptual view illustrating a section of a cigarette portion perpendicular to a longitudinal direction of the consumer product illustrated in FIG. 7A.

FIG. 8 is a sectional view illustrating a state in which the consumer product is contained in the flavor inhaler.

FIG. 9 is a sectional view illustrating a state in which the consumer product is contained in the flavor inhaler.

FIG. 10 is a sectional view illustrating a state in which the consumer product is contained in the flavor inhaler.

FIG. 11 is a flowchart illustrating a flow of a method for releasing a flavor according to the embodiment.

FIG. 12 is a conceptual view illustrating a section of a cigarette portion perpendicular to a longitudinal direction of a consumer product according to a first modification.

FIG. 13A is a side view schematically illustrating a heater according to a second modification.

FIG. 13B illustrates a section taken along line B-B of FIG. 13A.

### DESCRIPTION OF EMBODIMENTS

Hereinafter, an embodiment according to the present invention will be described with reference to the drawings. In the drawings described below, the same or equivalent elements are denoted by the same reference numerals, thereby omitting duplicate description thereof. Although description will be made with a cigarette stick as an example of a consumer product in the following embodiment, the consumer product is not limited to a cigarette as long as a product generates a flavor when heated.

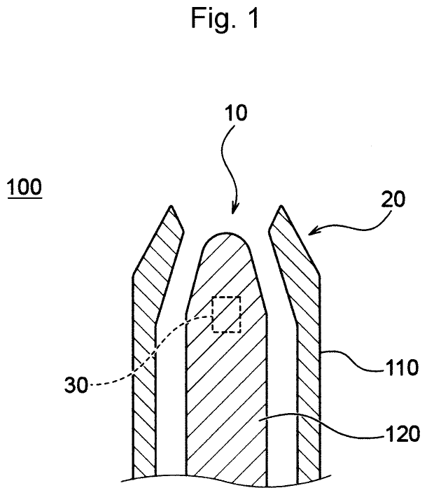

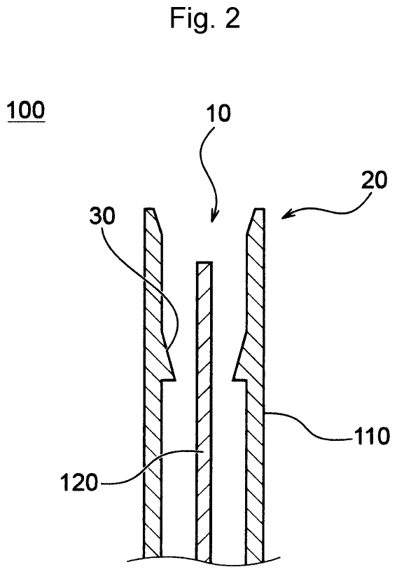

FIG. 1 is a sectional view illustrating a main portion of a flavor inhaler 100 according to an embodiment of the present invention in a width direction of a heater 120. FIG. 2 is a sectional view illustrating the main portion of the flavor inhaler 100 in a thickness direction of the heater 120.

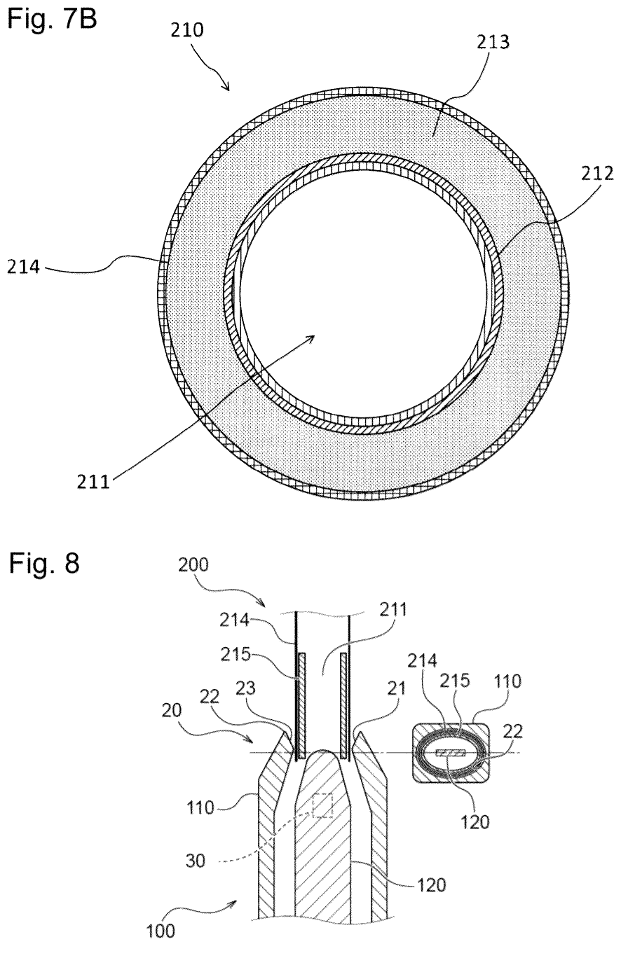

As illustrated in FIGS. 1 and 2, the flavor inhaler 100 includes a housing 110 and the heater 120. The housing 110 has an opening 10 at one end and functions as a container that is contains at least part of a consumer product 200 (FIG. 7A) inserted into the opening 10 through the opening 10. The housing 110 can be formed of, for example, resin and particularly formed of polycarbonate (PC), acrylonitrile-butadiene-styrene (ABS) resin, polyether ether ketone (PEEK), a polymer alloy including a plurality of types of polymers, or the like. Alternatively, the housing can be formed of metal such as aluminum. Here, the housing 110 has a structure in which the sectional area of a section perpendicular to a longitudinal direction of the housing 110 is minimized at a portion near the opening 10.

The housing 110 also has a shaping guide (guide portion) 20 and a pressure rib (urging portion) 30. The shaping guide 20 defines the opening 10 and deforms in section the consumer product 200 inserted into the housing 110 such that the shape of the consumer product 200 corresponds to the shape of the heater 120. The pressure rib 30 is provided at an inner circumferential surface of the housing 110 and urges the consumer product 200 inserted into the housing 110 toward the heater 120 so as to deform the consumer product 200.

Furthermore, an inlet (not illustrated) is provided on an opposite side of the housing 110 from the opening 10, that is, at a bottom portion of the housing 110. When air is supplied to the consumer product 200 inserted into the housing 110 through this inlet, a bottom flow-type flavor inhaler 100 is configured. When the inlet is provided on the opposite side of the housing 110 from the opening 10, the structure of the housing 110 near the opening 10 can be simplified. As long as the consumer product 200 can be secured to the heater 120 at a desired accuracy, the shape of the housing 110 is not particularly limited. For example, the shaping guide 20 or the pressure rib 30 is not necessarily provided.

The heater 120 is a positive temperature coefficient (PTC) heater having a planar shape that is inserted into the consumer product 200 having been contained in the housing 110 and heats the consumer product 200 from inside. Furthermore, the heater 120 changes the external shape of the consumer product 200 inserted into the housing 110 to follow the shape of the heater 120.

The PTC heater uses a resistor having a characteristic (PTC characteristic) with which, when a certain temperature (referred to as Curie temperature) is reached, electricity does not flow through the resistor due to a sudden increase in electric resistance. When using the PTC characteristic, the PTC heater can maintain the temperature at a temperature lower than or equal to a certain temperature without a control device or the like that stops the heater from heating when the temperature reaches a temperature higher than or equal to a predetermined temperature. The heater 120 may be a PTC heater including, as the resistor, barium titanate (BaTiO3) having a PTC characteristic. In such a case, since the Curie temperature of barium titanate can be set to 350° C., the heater 120 can heat the consumer product 200 at a preferred temperature lower than 350° C.

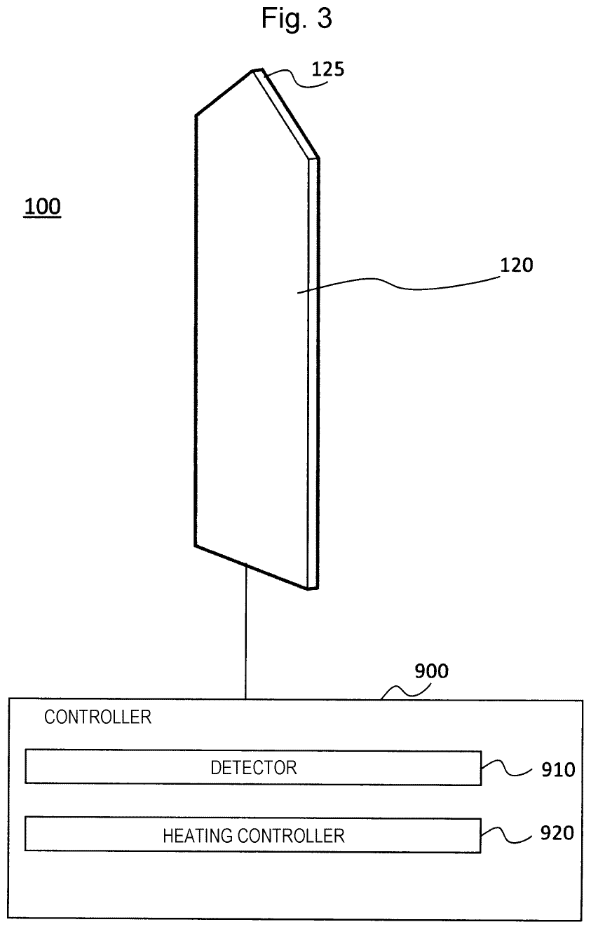

FIG. 3 is a conceptual view schematically illustrating the heater 120 and a controller 900 that controls the heater 120. The heater 120 is illustrated in a perspective view in FIG. 3. As will be described later, although the heater 120 includes a plurality of heating elements and a plurality of layers at least including a first electrode, illustration of the details is omitted in FIG. 3. The flavor inhaler 100 includes the controller 900 electrically connected to the heater 120. The controller 900 includes a detector 910 and a heating controller 920.

The heater 120 has a projection 125 formed on one side in a longitudinal direction. When the heater 120 is inserted into the consumer product 200, the projection 125 is inserted first. Accordingly, the side of the heater 120 where the projection 125 is formed is a side close to the outside when the consumer product 200 is contained in the housing 110, and this side is a downstream side of a flow path of air in inhalation. From this viewpoint, in the longitudinal direction of the heater 120, the side where the projection 125 is formed is referred to as the downstream side and an opposite side from the downstream side is referred to as an upstream side in the embodiment below.

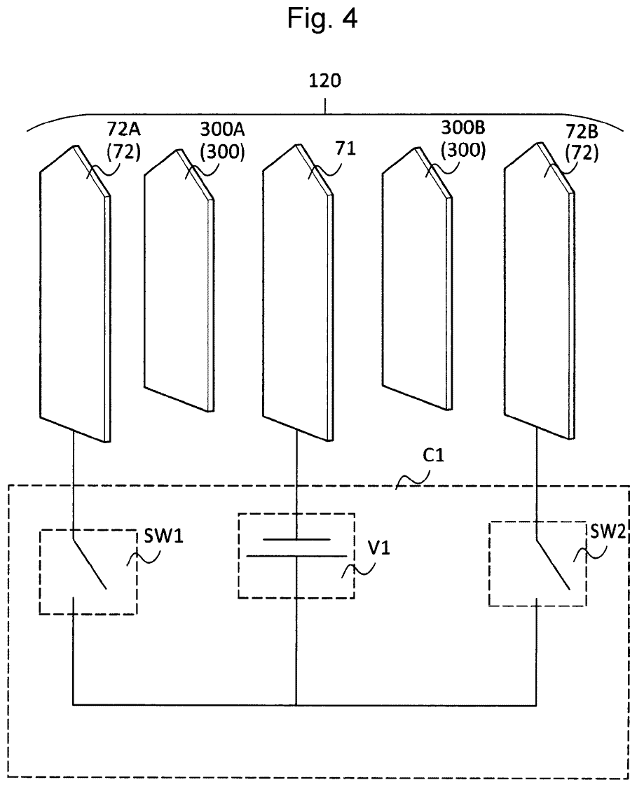

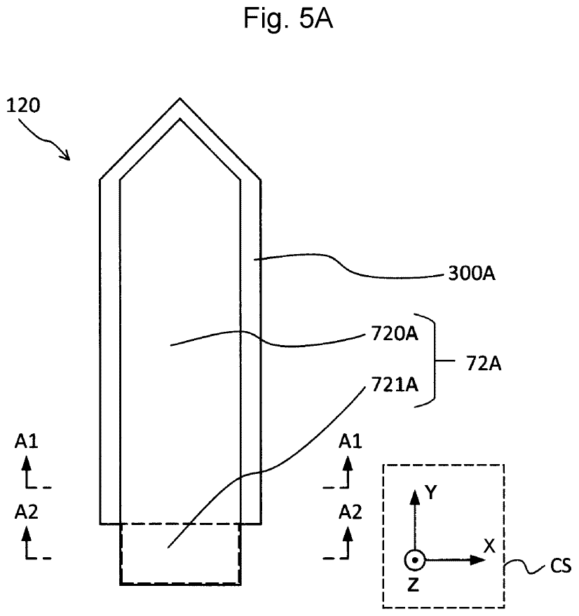

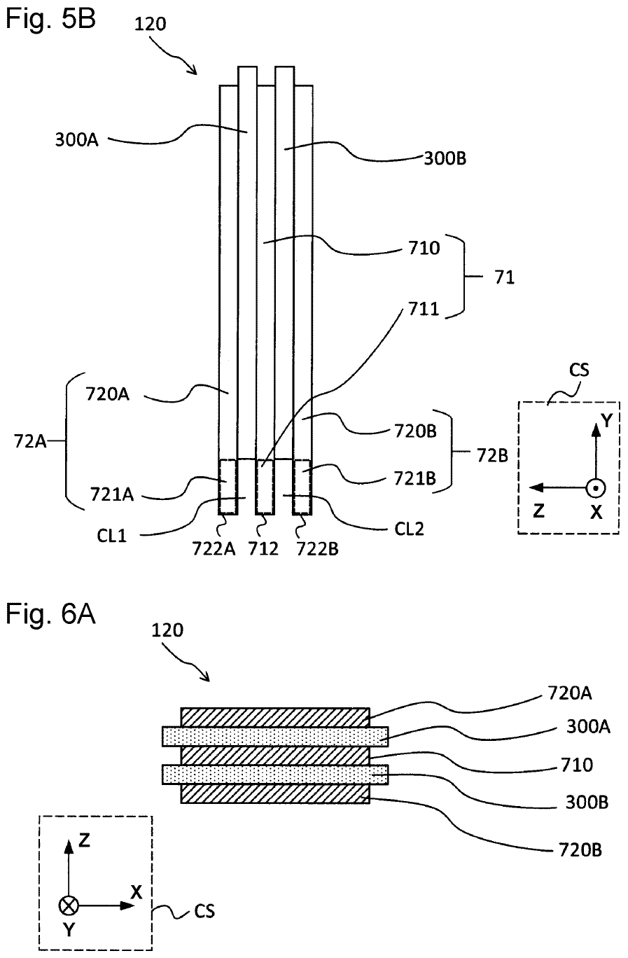

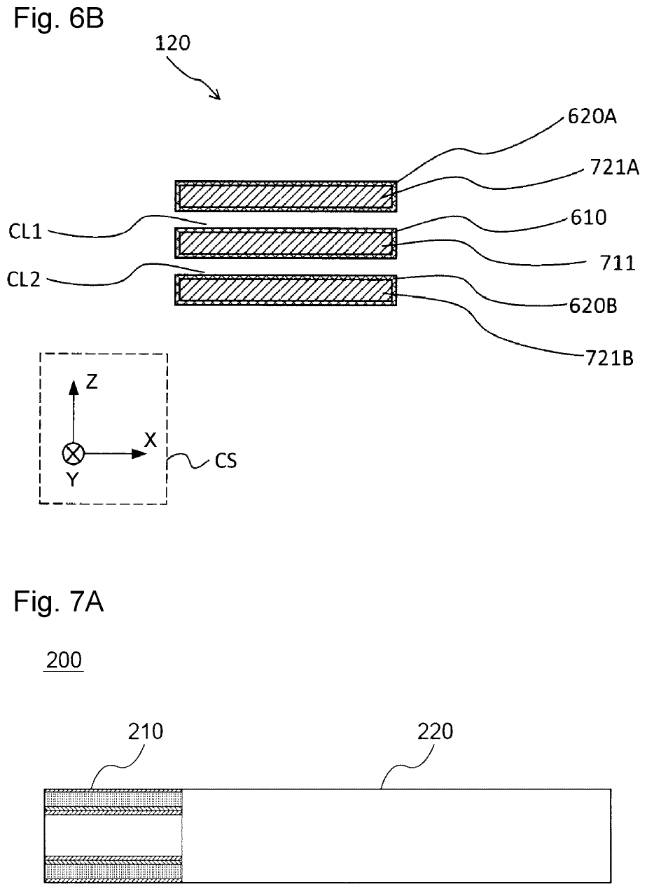

FIG. 4 is an exploded view schematically illustrating the structure of the heater 120. FIG. 5A is a general plan view schematically illustrating the heater 120 seen from a side of a second electrode 72A. FIG. 5B is a side view schematically illustrating the heater 120. FIGS. 6A and 6B schematically respectively illustrate a section taken along line A1-A1 of FIG. 5A and a section taken along line A2-A2 of FIG. 5A.

The heater 120 includes a plurality of heating elements 300A and 300B, a first electrode 71, and a plurality of second electrodes 72A and 72B. The second electrode 72A, the heating element 300A, the first electrode 71, the heating element 300B, and the second electrode 72B are stacked in this order, and the adjacent layers are electrically connected (see FIG. 5B). Hereinafter, when the heating elements 300A and 300B are not distinguished from each other, each of the heating elements 300A and 300B is referred to as the heating element 300. Hereinafter, when the plurality of second electrodes 72A and 72B are not distinguished from each other, each of the second electrodes 72A and 72B is referred to as the second electrode 72. Hereinafter, the heating element 300 extends in the longitudinal direction along the XY plane. The Y axis extends in the longitudinal direction, the X axis extends perpendicular to the Y axis, and the Z axis extends perpendicular to the XY plane (see the coordinate system CS).

The flavor inhaler 100 includes a circuit C1. The circuit C1 is electrically connected to the first electrode 71, the second electrode 72A, and the second electrode 72B. The circuit C1 is configured so as to apply a voltage between the first electrode 71 and the second electrode 72A and between the first electrode 71 and the second electrode 72B. In the illustrated example, the circuit C1 includes a direct-current power source V1, a first switch SW1, and a second switch SW2. The direct-current power source V1 is electrically connected to the first electrode 71. The first switch SW1 is electrically connected to the direct-current power source V1 and the second electrode 72A. The second switch SW2 is electrically connected to a direct-current power source V2 and the second electrode 72B. The first switch SW1 and the second switch SW2 are arranged in parallel. The heating controller 920 can control each of the first switch SW1 and the second switch SW2. Thus, heating of the heating element 300A and heating of the heating element 300B can be controlled independently of each other. Although a simple circuit configuration is illustrated in FIG. 4 for ease of understanding, the form of the circuit C1 is not particularly limited as long as the heating of the heating elements 300A and 300B can be controlled.

The heating element 300 is preferably the PTC element. Due to the above-described PTC characteristic, a current is unlikely to flow through the PTC element when the temperature increases to the predetermined temperature. Accordingly, when the PTC element is used as the heating element 300, complex control is not necessary, and a safe flavor inhaler can be provided.

The heating element 300 has a planar shape extending in the longitudinal direction. The shape of the heating element 300 is not particularly limited. However, when the heating element 300 has a planar shape, the heating element 300 can have a more compact structure due to the stacking, and the voltage can be efficiently applied. Thus, the heating element 300 preferably has a planar shape.

As illustrated in FIGS. 5A and 5B, the first electrode 71 includes a first electrode main body 710 and a first connection electrode 711. The first connection electrode 711 is formed on the upstream side of the first electrode main body 710. A connection portion 712 connected to the circuit C1 is formed at an end surface of the first connection electrode 711 on the upstream side. The second electrode 72A includes a second electrode main body 720A and a second connection electrode 721A. The second connection electrode 721A is formed on the upstream side of the second electrode main body 720A. A connection portion 722A is formed at an end surface of the second connection electrode 721A on the upstream side. The second electrode 72B includes a second electrode main body 720B and a second connection electrode 721B. The second connection electrode 721B is formed on the upstream side of the second electrode main body 720B. A connection portion 722B connected to the circuit C1 is formed at an end surface of the second connection electrode 721B on the upstream side.

According to the present embodiment, the first electrode 71 refers to an electrode disposed between the plurality of heating elements 300 and electrically connected to each of the plurality of heating elements 300. The heater 120 may have a structure in which the heater 120 includes three or more heating elements 300 and two or more first electrodes 71 and each of the first electrodes 71 is disposed between the heating elements 300 facing each other. As described above, in the heater 120, the plurality of heating elements 300 are stacked with at least one first electrode 71 interposed therebetween. Thus, by using the plurality of heating elements 300, heating of a cigarette portion 210 (FIG. 7A) can be more flexibly controlled. Accordingly, release of a flavor component from the flavor inhaler 100 can be more flexibly controlled. Furthermore, when a single first electrode 71 is used to heat the plurality of heating elements 300, the heater 120, the flavor inhaler 100, and a flavor inhaling system can have a compact structure. In addition, the heater 120, the flavor inhaler 100, and a flavor inhaling system can be efficiently manufactured.

When the heating element 300A is defined as a first heating element and the heating element 300B is defined as a second heating element, the first heating element, the second heating element, and the first electrode 71 each have a planar shape, and the first heating element and the second heating element are disposed so as to face each other with the first electrode 71 interposed therebetween. In the flavor inhaler 100 according to the present embodiment, the plurality of heating elements 300 preferably include such a first heating element and a second heating element. Thus, the planar heater 120 in which the first heating element, the first electrode 71, and the second heating element are stacked in this order can be provided. Accordingly, a more compact structure is achieved, and the voltage can be efficiently applied to the first heating element and the second heating element.

The second electrodes 72 refer to electrodes stacked outside heating elements 300 out of the plurality of heating elements 300 disposed outermost. In the example illustrated in FIG. 5B, the heater 120 includes two heating elements 300. Accordingly, both the heating element 300A and the heating element 300B are the heating elements 300 disposed outermost.

The first electrode 71 and the second electrodes 72 have a planar shape extending in the longitudinal direction. The shape of the first electrode 71 or the second electrodes 72 is not particularly limited. However, when the first electrode 71 or the second electrodes 72 have a planar shape, a more compact structure can be obtained due to the stacked structure, and the voltage can be efficiently applied to the heating elements 300. Thus, the first electrode 71 or the second electrodes 72 preferably have a planar shape. The material of the first electrode 71 or the second electrodes 72 is not particularly limited as long as the material has conductivity. From the viewpoint of facilitating processing of the heater 120, the first electrode 71 and the second electrodes 72 are preferably a conductive adhesive or metal electrodes. Examples of the conductive adhesive can include, for example, a so-called anisotropic conductive adhesive in which conductive particles are uniformly dispersed in an epoxy-based adhesive.

At least one of the first electrode 71 and the second electrodes 72 includes a conductive supporting member having a planar shape. Thus, a malfunction and destruction of the heater 120 due to deformation can be suppressed. Furthermore, since the first electrode 71 or the second electrode 72 also serves as a supporting body, the heater 120, the flavor inhaler 100, and the flavor inhaling system can have a compact structure. In addition, the heater 120, the flavor inhaler 100, and the flavor inhaling system can be efficiently manufactured. From the viewpoints of stiffness and durability, the supporting member preferably includes stainless steel. Conductive or non-conductive supporting member having a planar shape may be disposed outside the second electrode 72, thereby to support the heater 120.

The first electrode 71 preferably includes a thermally insulative material. This can suppress thermal transmission between the plurality of heating elements 300 via the first electrode 71, and accordingly, the temperature of each of the heating elements 300 can be more accurately controlled. Furthermore, heat generated by the heating elements 300 can be efficiently directed toward the consumer product 200. Examples of the thermally insulative material include, for example, silica aerogel and carbon aerogel. The first electrode 71 itself may have a porous structure.

As illustrated in FIGS. 5A, 5B, and 6A, the second electrode main body 720A, the heating element 300A, the first electrode main body 710A, the heating element 300B, and the second electrode main body 720B are stacked in this order. Meanwhile, in the heater 120, the first connection electrode 711, the second connection electrode 721A, and the second connection electrode 721B are formed so as to protrude toward the upstream side in the longitudinal direction and have respective connection portions 712, 722A, and 722B formed at respective end portions. The first connection electrode 711 faces the second connection electrode 721A with a clearance CL1 interposed therebetween and the second connection electrode 721B with a clearance CL2 interposed therebetween.

As described above, in at least one electrode out of the first electrode 71 and the second electrodes 72, a connection electrode is preferably formed as follows: the connection electrode is formed along a plane (XY plane) in which the heating element 300 adjacent to the electrode (adjacent heating element) extends, and the connection electrode protrudes in the longitudinal direction of the heating element from a range in which the adjacent heating element 300 extends. This facilitates electrical connection to the circuit C1 in the connection portions 712, 722A, and 722B. The connection portions 712, 722A, and 722B may be provided in surfaces respectively connected to the end surfaces in the first connection electrode 711, the second connection electrode 721A, and the second connection electrode 721B, that is, surfaces along the longitudinal direction (Y axis direction). For example, lead wires can be connected to the surfaces near the respective end surfaces of the first connection electrode 711, the second connection electrode 721A, and the second connection electrode 721B.

As illustrated in FIG. 6B, in the first connection electrode 711 and the second connection electrodes 721A and 721B, the surfaces other than connection portions 712, 722A, and 722B are coated. A coating 610 is formed on the surface of the first connection electrode 711. A coating 620A and a coating 620B are respectively formed on the surface of the second connection electrode 721A and the surface of the second connection electrode 721B. Accordingly, shorting in a direction perpendicular to the longitudinal direction (Y axis direction) of the heating elements 300 can be prevented. From the viewpoint of suppressing the shorting, the first electrode main body 710 and the second electrode main bodies 720A and 720B may be coated.

In contrast, as illustrated in FIGS. 5A and 6A, electrodes other than the first connection electrode 711 and the second connection electrodes 721A and 721B, that is, the first electrode main body 710 and the second electrode main body 720A and 720B do not protrude from the range in which the adjacent heating elements 300 extend along the plane (XY plane) in which the adjacent heating elements 300 extend. For example, as illustrated in FIG. 5A, the second electrode main body 720A is formed within a range of an XY plane in which the adjacent heating element 300A extends in top view and does not protrude from the range. With such a configuration, shorting in the Z axis direction perpendicular to the plane in which the heating elements 300 extend can be suppressed. From the viewpoint of suppressing the shorting, preferably, none of the electrodes other than the first connection electrode 711 and the second connection electrodes 721A and 721B protrude from the range of the XY plane in which all the heating elements 300 extend.

Referring back to FIG. 3, the controller 900 includes a processing device such as a printed circuit board (PCB). This processing device includes a CPU and memory and controls operation of the flavor inhaler 100.

The detector 910 detects the start of inhalation. The detector 910 detects an operation performed by a user on an input device such as a push button or a slide switch (not illustrated). Alternatively, the detector 910 detects puff action performed by the user. After the detection, the detector 910 performs a process so as to cause the heating controller 920 to start application of the voltage for heating.

The heating controller 920 electrically controls each of the first electrode 71, the second electrode 72A, and the second electrode 72B to control heating of each of the heating element 300A and the heating element 300B. The heating controller 920 is preferably configured to control the voltage applied to the heating element 300A or a current flowing through the heating element 300A and the voltage applied to the heating element 300B or a current flowing through the heating element 300B so that the voltage applied to the heating element 300A or the current flowing through the heating element 300A and the voltage applied to the heating element 300B or the current flowing through the heating element 300B can be controlled independently of each other. In this case, the heating controller 920 is configured to control heating of the heating element 300A and heating of the heating element 300B so that the heating of the heating element 300A and the heating of the heating element 300B can be controlled independently of each other.

In the example according to the present embodiment, after heating the heating element 300A, the heating controller 920 electrically controls the first electrode 71, the second electrode 72A, and the second electrode 72B so as to heat the heating element 300B. When the heating element 300A being a subset of the heating elements is heated ahead of the other as described above, the temperature of a flavor generating substrate heated by the heating element 300A having been heated before increases quickly. This can reduce a time period from a time at which the flavor inhaler 100 is started to a time at which the user can inhale the flavor.

The heating controller 920 heats the heating element 300A when the detector 910 performs a process indicating detection of the start of inhalation. The heating controller 920 starts the heating of the heating element 300B when a switching condition has been satisfied. The switching condition is a lapse of a predetermined time period from the start of the heating of the heating element 300A, the presence of input by the user via an input device (not illustrated), or the like. For example, the following configuration is possible: a button is disposed in the flavor inhaler 100, and the heating controller 920 starts the heating of the heating element 300B when the user presses the button. When the heating of the heating element 300B is started, whether to stop the heating of the heating element 300A is not particularly limited.

The heating controller 920 ends the heating of the heating element 300B when an ending condition has been satisfied. The ending condition is a lapse of a predetermined time from the start of the heating, the fact that the number of times of the puff action performed by the user exceeds a certain value, or the like. The control performed by the heating controller 920 is not limited to the above-described example and can be appropriately set depending on the desired form of heating. For example, the heating element 300A may be heated after the heating of the heating element 300B.

FIG. 7A is a schematic side sectional view illustrating the consumer product 200 according to the present embodiment. FIG. 7B is a sectional view illustrating a section of the cigarette portion 210 perpendicular to the longitudinal direction of the consumer product 200 illustrated in FIG. 7A. The consumer product 200 includes the cigarette portion (non-insertion portion) 210 and a paper tube 220. The cigarette portion 210 has, at the center, a through hole 211 into which the heater 120 is inserted. Furthermore, the cigarette portion 210 includes a two-layer structure including a flavor release layer (annular sheet) 212 and an elastic deformation layer (annular sheet) 213 disposed so as to surround the heater 120 to be inserted. A wrapper 214 is wrapped around an outer circumference of the elastic deformation layer 213.

The flavor release layer 212 includes, for example, a cigarette sheet and a non-cigarette sheet that is disposed at an outer circumference of the cigarette sheet and carries glycerine. The flavor release layer 212 is heated by the heater 120 to release a volatile chemical compound including a flavor. The flavor release layer 212 may include only one of the cigarette sheet and the non-cigarette sheet. The elastic deformation layer 213 includes, for example, a nonwoven fabric sheet, a corrugated sheet, a non-cigarette sheet, or the like and elastically deformable in its thickness direction (that is, a radial direction of the elastic deformation layer 213 having a cylindrical shape). When the heater 120 is inserted, the elastic deformation layer 213 contributes to the deformation of the consumer product 200 to follow the shape of the heater 120.

Accordingly, when the heater 120 is inserted into the through hole 211, the elastic deformation layer 213 elastically deforms in the thickness direction relative to the heater 120. Thus, the elastic deformation layer 213 becomes likely to be brought into contact with or move close to the heater 120. Thus, the flavor release layer 212 can be brought into better contact with or move closer to the heater 120, and accordingly, the consumer product 200 can be efficiently heated.

The paper tube 220 cools the volatile chemical compound released from the flavor release layer 212. The cigarette portion 210 includes the flavor release layer 212 and the elastic deformation layer 213 disposed so as to surround the heater 120 to be inserted. Thus, when the heater 120 is inserted into the consumer product 200, the consumer product 200 can be easily deformed. The sectional shape of the consumer product 200 may be circular or elliptical.

Here, the non-cigarette sheet may include the flavor generating substrate. The flavor generating substrate is a material providing a flavor and smoke taste and preferably a cigarette material. The flavor generating substrate can include a flavor agent. The flavor agent is a substance providing flavor and taste. The flavor agent may be a natural flavor agent or a synthetic flavor agent. As the flavor agent, a single type of a flavor agent may be used or a mixture of a plurality of types of flavor agents may be used. Furthermore, as the flavor agent, any flavor agent can be used as long as the flavor agent is a generally used flavor agent such as, for example, an essential oil, a natural flavor agent, or a synthetic flavor agent. The flavor agent may be a liquid or a solid and may have any material properties. Furthermore, the flavor generating substrate may include an algefacient or a tasting agent.

Furthermore, the cigarette sheet can include, for example, a cigarette, a polyhydric alcohol, or the like. A single type of or a combination of two or more types of the polyhydric alcohols can be used for the cigarette sheet. The polyhydric alcohol can also be added to the above-described elastic deformation layer 213. The cigarette sheet can be formed into a sheet shape by mixing a binder with a powdery cigarette and the polyhydric alcohol.

Next, the relationships among the consumer product 200, the housing 110, and the heater 120 when the consumer product 200 is contained in the flavor inhaler 100, that is, the consumer product 200 is inserted from one end side toward the other end side of the housing 110 are described. FIGS. 8 to 10 are sectional views illustrating states in which the consumer product 200 is contained in the flavor inhaler 100. Here, when the consumer product 200 is applied to the flavor inhaler 100, the flavor inhaling system is configured. Referring to FIGS. 8 to 10, the flavor release layer 212 and the elastic deformation layer 213 of the consumer product 200 is indicated as a single annular sheet 215.

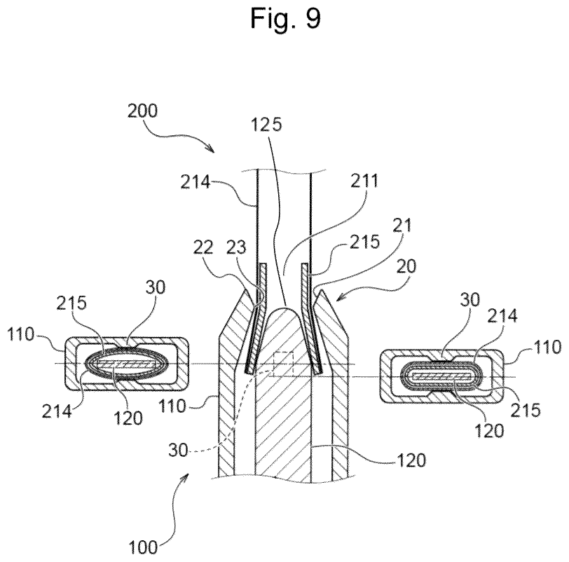

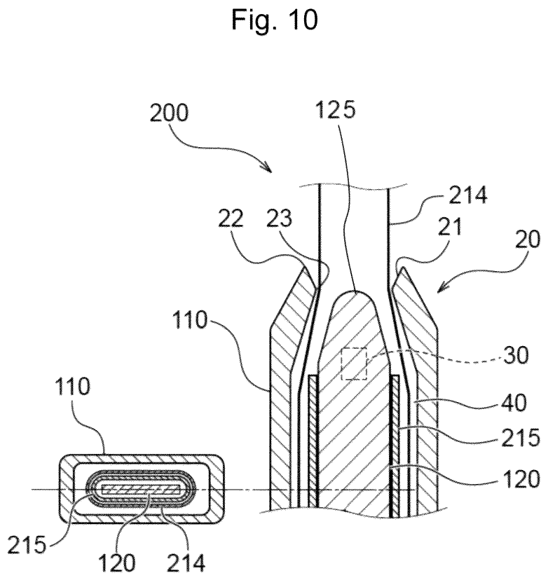

FIG. 8 illustrates a state in which the consumer product 200 is passing through the shaping guide 20 in a section of the heater 120 in the width direction and a section perpendicular to the longitudinal direction of the housing 110 at an entrance portion 22 of the shaping guide 20. FIG. 9 illustrates a state in which the consumer product 200 is passing through the pressure rib 30 in the section of the heater 120 in the width direction and the section perpendicular to the longitudinal direction of the housing 110 at an intermediate portion the pressure rib 30 and an end portion of the pressure rib 30 on the other end side. FIG. 10 illustrates a state in which the consumer product 200 is contained in a predetermined containing position in the housing 110 in the section of the heater 120 in the width direction and the section perpendicular to the longitudinal direction of the housing 110 near an end portion of the heater 120 on the other end side.

As illustrated in FIG. 8, the shaping guide 20 has a tapered portion 21, the entrance portion 22, and a contact portion 23. The tapered portion 21 has a structure in which the size of the tapered portion 21 increases toward the one end of the housing 110 and guides the insertion of the consumer product 200 into the flavor inhaler 100. The entrance portion 22 is provided at an end portion of the housing 110 and has a structure in which the entrance portion 22 has an elliptical section, the large diameter of the entrance portion 22 is greater than or equal to the large diameter of the consumer product 200 after the consumer product 200 has been contained in the housing 110, and the small diameter of the entrance portion 22 is substantially the same as the diameter of the consumer product 200 before the consumer product 200 is contained in the housing 110. Furthermore, the contact portion 23 is provided at the inner circumferential surface of the housing 110 and has a structure in which the contact portion 23 has an elliptical section, and a minimum length of the inner circumference of the contact portion 23 is substantially equal to the length of an outer circumference of the consumer product 200. Thus, when the consumer product 200 passes through the shaping guide 20, the entire circumference of the consumer product 200 is brought into contact with the contact portion 23, and accordingly, the sectional shape of the consumer product 200 can be changed follow the shape of the entrance portion 22.

As illustrated in FIG. 9, the heater 120 has the projection 125 having a narrow end on the one side. This can facilitate the insertion of the heater 120 into the consumer product 200. The heater 120 has a structure in which the width of the heater 120 increases toward the other end side. Thus, as the consumer product 200 is passing through the shaping guide 20 and being inserted, the external shape of the consumer product 200 is changed to follow the shape of the heater 120. Specifically, the consumer product 200 extends in the width direction of the heater 120. Thus, the consumer product 200 can be brought into close contact with the heater 120, and heat transfer efficiency from the heater 120 to the consumer product 200 can be improved. Furthermore, when the heater 120 extends the consumer product 200, fall of the consumer product 200 can be prevented.

Specifically, the heater 120 has a planar shape and changes the external shape of the consumer product 200 inserted into the housing 110 so that the consumer product 200 has an elliptical sectional shape. At this time, the large diameter of the consumer product 200 after the consumer product 200 has been contained in the housing 110 is greater than the diameter of the consumer product 200 before the consumer product 200 is contained in the housing 110, and the small diameter of the consumer product 200 after the consumer product 200 has been contained in the housing 110 is smaller than the diameter of the consumer product 200 before the consumer product 200 is contained in the housing 110. The heater 120 changes the external shape of the consumer product 200 inserted into the housing 110 so that the consumer product 200 has an elliptical sectional shape. This reduces the distance of the housing 110 in the lateral direction occupied by the consumer product 200. Accordingly, the thickness of the housing 110 can be reduced. Furthermore, the heater 120 changes the external shape of the consumer product 200 inserted into the housing 110 so that the consumer product 200 has an elliptical sectional shape. This can increase the contact area between the heater 120 and the consumer product 200. Thus, heat transfer efficiency from the heater 120 to the consumer product 200 can be improved.

As illustrated in FIG. 10, in a state in which the consumer product 200 is contained in the predetermined containing position in the housing 110, an air layer 40 is formed between the consumer product 200 and the housing 110 at the entire circumference of the consumer product 200. Since the heat conductivity is low in the air layer 40, the consumer product 200 and the housing 110 can be thermally insulated from each other, and accordingly, the amount of energy required to heat the consumer product 200 can be reduced. Furthermore, the entrance portion 22 is in contact with consumer product 200 throughout the outer circumference of the consumer product 200 to seal the air layer 40. This suppresses convection of air in the air layer 40.

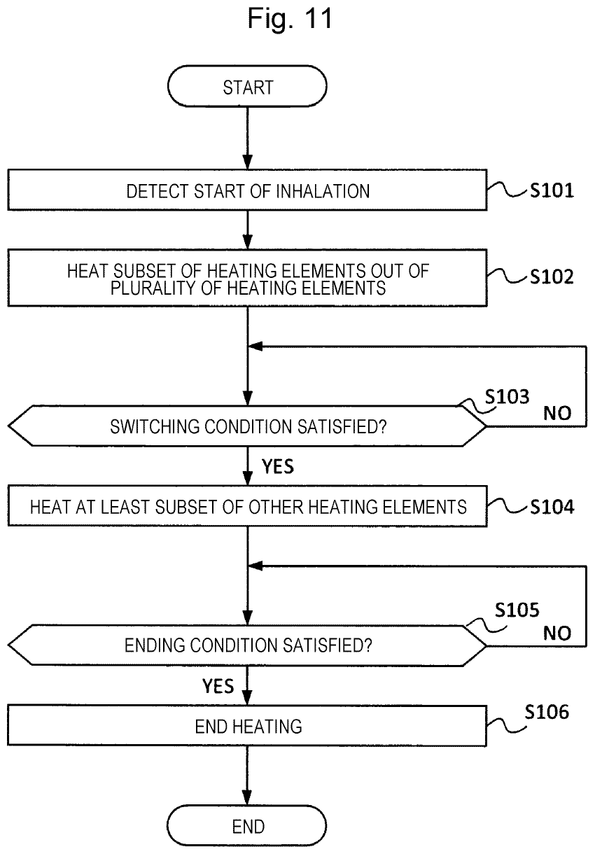

FIG. 11 is a flowchart illustrating a flow of a method for releasing a flavor according to the present embodiment. This method for releasing is performed by the controller 900. According to this method for releasing, the heating elements 300A and 300B are independently heated and controlled. Thus, releasing of the flavor component can be flexibly controlled. Furthermore, when the inhalation is started, a subset of the plurality of heating elements 300 is heated, and accordingly, the time period required to start generating the flavor can be reduced.

In step S101, the detector 910 detects the start of inhalation performed by the user. After the step S101, step S102 is performed. In step S102, the heating controller 920 heats the heating element 300A being a subset of the plurality of heating elements 300. After the step S102, step S103 is performed.

In step S103, the heating controller 920 determines whether the switching condition has been satisfied. When the switching condition has been satisfied, a positive determination is made in step S103, and step SS104 is performed. When the switching condition has not been satisfied, a negative determination is made in step S103, and step S103 is repeated.

In step S104, the heating controller 920 heats the heating element 300B being at least a subset of heating elements other than the heating element 300A. After the step S104, step S105 is performed.

In step S105, the heating controller 920 determines whether the ending condition has been satisfied. When the ending condition has been satisfied, a positive determination is made in step S105, and step SS106 is performed. When the ending condition has not been satisfied, a negative determination is made in step S105, and step S105 is repeated.

In step S106, the heating controller 920 ends the heating. When step S106 is ended, the process is ended.

In the flavor inhaler 100 and the method for releasing a flavor according to the present embodiment, the heating controller 920 controls the heater 120 so as to heat the heating element 300A being a subset of the plurality of heating elements 300, and after that, heat the heating element 300B being at least a subset of the other heating elements 300. This can reduce a time period required to allow the user to inhale the flavor.

Modifications described below are also within the scope of the present invention and able to be combined with the above-described embodiment or other modifications. In the following modifications, portions and the like indicating structures or functions the same as or similar to those of the above-described embodiment are denoted by the same reference numerals, thereby omitting the description as appropriate.

### (First Modification)

In the above-described embodiment, the consumer product may include a plurality of flavor release layers containing respective flavor components.

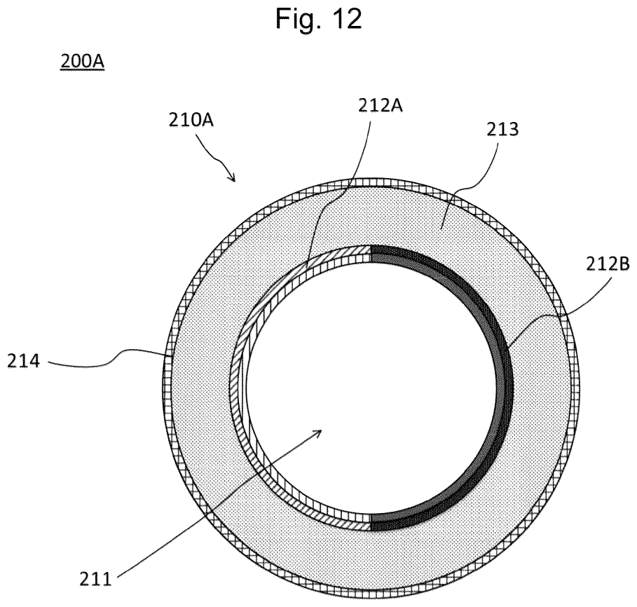

FIG. 12 is a conceptual view illustrating a section of a cigarette portion perpendicular to the longitudinal direction of a consumer product according to the present modification. A consumer product 200A is different from the consumer product 200 of the above-described embodiment in that the consumer product 200A includes a cigarette portion 210A instead of the above-described cigarette portion 210 (see FIG. 7A).

The cigarette portion 210A includes a first flavor release layer 212A and a second flavor release layer 212B. The first flavor release layer 212A and the second flavor release layer 212B are disposed on respective sides of the through hole 211 into which the heater 120 is inserted. Accordingly, when the consumer product 200A is contained in the housing 110, the first flavor release layer 212A and the second flavor release layer 212B can be disposed at respective positions facing the heating element 300A and the heating element 300B (or at the respective positions facing the heating element 300B and 300A). The first flavor release layer 212A can be heated by a subset of the heating elements out of the plurality of heating elements 300, and the second flavor release layer 212B can be heated by the other heating element 300 out of the plurality of heating elements 300. A mark or the like for positioning is preferably provided in the consumer product 200A so that, when the consumer product 200A is contained in the housing 110, the first flavor release layer 212A and the second flavor release layer 212B are disposed at the respective positions facing the corresponding heating elements 300.

From the viewpoint of providing a flavor inhaling system that allows the flavor to change, the first flavor release layer 212A and the second flavor release layer 212B preferably contain different flavor components. However, the flavor component disposed in the first flavor release layer 212A or the second flavor release layer 212B is not particularly limited. The first flavor release layer 212A and the second flavor release layer 212B may include the same flavor component. The cigarette portion 210A may include three or more flavor release layers including the same or different flavor components.

In the flavor inhaling system according to the present modification, the consumer product 200A includes the first flavor release layer 212A and second flavor release layer 212B being a plurality of portions including the same or different flavor components. The first flavor release layer 212A and the second flavor release layer 212B are configured so that, when inhalation is performed, the first flavor release layer 212A and the second flavor release layer 212B are disposed at the positions facing the respective heating elements 300. Accordingly, release of the flavor components from the flavor inhaling system can be more flexibly controlled. Furthermore, the flavor components can be disposed in the plurality of portions depending on a taste of the user, convenience, or the like.

### (Second Modification)

In the above-described embodiment, the first electrode may include a plurality of different current-carrying regions that heat different portions of the heating elements.

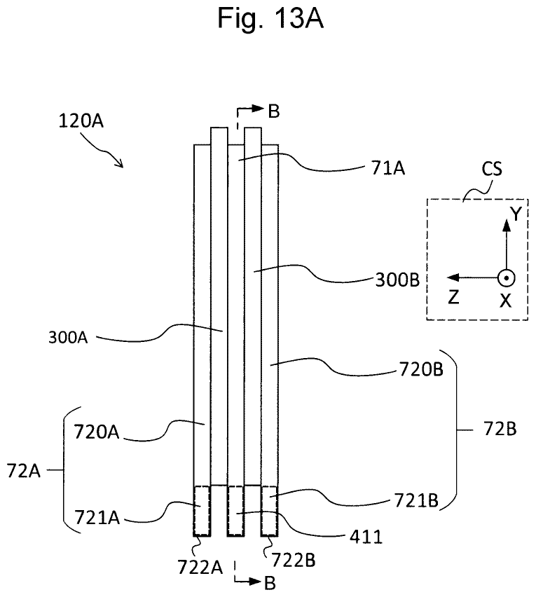

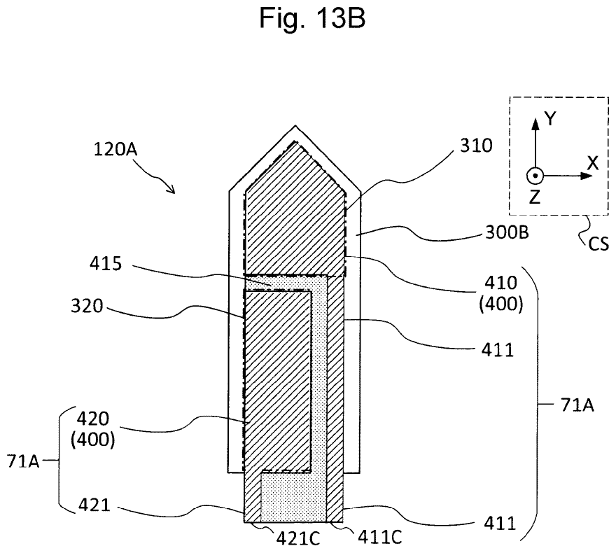

FIG. 13A is a side view schematically illustrating a heater 120A according to the present modification. FIG. 13B is a sectional view taken along line B-B of FIG. 13A. The heater 120A is different from the heater 120 of the above-described embodiment in that the heater 120A includes a first electrode 71A instead of the above-described first electrode 71.

The first electrode 71A includes a plurality of current-carrying regions 400 and a plurality of connection regions 411 and 421. The plurality of current-carrying regions 400 include a downstream region 410 and an upstream region 420. The downstream region 410 is formed on the downstream side of the upstream region 420. In the heating element 300B adjacent to the first electrode 71A, a portion facing the downstream region 410 is referred to as a first heating section 310, and a portion facing the upstream region 420 is referred to as a second heating section 320. Although a first heating section and a second heating section are similarly set in the heating element 300A, description of thereof is omitted.

The first heating section 310 is interposed between the downstream region 410 and the second electrode main body 720B in the normal direction (hereinafter, simply referred to as the normal direction, and corresponding to the Z axis direction) to a plane (XY plane) in which the planar heating element 300B extends. The first heating section 310 is in contact with and electrically connected to the downstream region 410 and the second electrode main body 720B. The first heating section 310 is heated by a current generated due to a voltage applied across the downstream region 410 and the second electrode 72B. The second heating section 320 is interposed between the upstream region 420 and the second electrode main body 720A in the normal direction. The second heating section 320 is in contact with and electrically connected to the upstream region 420 and the second electrode main body 720B. The second heating section 320 is heated by a current generated due to a voltage applied across the upstream region 420 and the second electrode 72B.

In the illustrated example, the downstream region 410 has planar shape and has, in top view, a pentagonal shape and the upstream region 420 has a planar shape and has, in top view, a rectangular shape. However, as long as the downstream region 410 and the upstream region 420 can be disposed so as to face respective different portions of the adjacent heating element 300, the shape or the size of the downstream region 410 or the upstream region 420 is not particularly limited.

The downstream region 410 is electrically connected to the controller 900 via the connection region 411. The connection region 411 is disposed in the longitudinal direction of the heating element 300 on the upstream side of the downstream region 410. The connection region 411 is electrically connected to the downstream region 410 at a first end thereof and connected to a conductive wire of the heater 120A outside the heater 120A via a connection portion 411C at a second end thereof. The connection portion 411C is an end surface on the upstream side of the connection region 411. The upstream region 420 is electrically connected to the controller 900 via the connection region 421. The connection region 421 is disposed in the longitudinal direction on the upstream side of the upstream region 420. The connection region 421 is electrically connected to the upstream region 420 at a first end thereof and connected to a conductive wire of the heater 120A outside the heater 120A via a connection portion 421C at a second end thereof. The connection portion 421C is an end surface on the upstream side of the connection region 421.

From the viewpoint of preventing shorting, a non-current-carrying region 415 is disposed between a region including the downstream region 410 and the connection region 411 and a region including the upstream region 420 and the connection region 421. From the viewpoint similar to the above description, an insulation treatment is applied, with a coating (not illustrated), to portions of the surfaces of the connection regions 411 and 421 other than the connection portions 411C and 421C. The material of neither this coating on the surfaces nor the non-current-carrying region 415 is particularly limited. For example, a coating with a glass can be used. Other than the connection regions 411 and 421, no electrode protrudes from a range in which the heating element 300 extends along the plane (XY plane) in which the planar heating element 300 extends. The reason for this is to suppress shorting that would otherwise be caused.

The material of the current-carrying regions 400, the connection region 411, or the connection region 421 is not particularly limited as long as these regions are conductive. The current-carrying regions 400, the connection region 411, and the connection region 421 preferably include metal or a conductive adhesive.

According to the present modification, the heating controller 920 can electrically control the downstream region 410, the upstream region 420, the second electrode 72A, and the second electrode 72B so that these regions and the electrodes are electrically controlled independently of each other. Accordingly, heating of the first heating section 310 and the second heating section 320 of the heating element 300B and a first heating section and a second heating section set in the heating element 300A similarly to those of the heating element 300B can be controlled independently of each other.

Preferably, when the detector 910 detects the start of the inhalation, the heating controller 920 heats the first heating section 310 disposed on the most downstream side. An aerosol released due to heating performed by the first heating section 310 disposed on the downstream side is unlikely to be blocked by other portions of the cigarette portion 210 because of a small distance to the paper tube 220. This can suppress reduction of the amount of the aerosol inhaled by the user immediately after the start of the inhalation. However, the configuration in which the first heating section 310 is heated first is not necessarily used. The positions or the number of the plurality of current-carrying regions 400 is not particularly limited. The positions and the number of the plurality of current-carrying regions 400 can be appropriately set depending on the form of the control of heating. For example, the plurality of current-carrying regions 400 may be arranged in a direction perpendicular to the flow path of air (Z axis direction).

Alternatively or additionally, similarly to the current-carrying regions 400, a plurality of current-carrying regions may be provided in the second electrode 72A or the second electrode 72B. In this case, current-carrying regions 400 facing each other with a single heating element 300 interposed therebetween preferably have a similar size and a similar shape. In this way, one of the current-carrying regions 400 preferably has a shape and a size based on the current-carrying region 400 facing the one current-carrying region 400 with the heating element 300 interposed therebetween. Thus, the temperature of the heating section disposed between these current-carrying regions 400 can be more accurately controlled.

In the flavor inhaler according to the present modification, one or more electrodes out of the first electrode 71A and the second electrodes 72 include a plurality of current-carrying regions 400. In the first electrode 71A as the example of such an electrode, the plurality of current-carrying regions 400 are disposed so as to respectively face the first heating section 310 and the second heating section 320 that are a plurality of heating portions of the heating element 300B adjacent to the first electrode 71A. This allows control of heating of each of these heating portions of the heating element 300, and accordingly, heating by using the heater 120A can be still more flexibly controlled.

The embodiment according to the present invention has been described above. However, the above-described embodiment according to the present invention is intended to facilitate understanding of the present invention and does not limit the present invention. The present invention can be changed or improved without departing from the gist thereof and includes equivalents thereof. In addition, the elements described in the claims and the description can be combined or omitted to an extent that at least part of the above-described problem can be solved or at least a subset of the effects is produced.

### REFERENCE SIGNS LIST

10 opening
20 shaping guide
30 pressure rib
71, 71A first electrode
72, 72A, 72B second electrode
100 flavor inhaler
110 housing
120, 120A heater
200, 200A consumer product
210, 210A cigarette portion
212 flavor release layer
212A first flavor release layer
212B second flavor release layer
220 paper tube
300, 300A, 300B heating element
310 first heating section
320 second heating section
400 current-carrying region
410 downstream region
411, 421 connection region
411C, 421C, 712, 722A, 722B connection portion
420 upstream region
610, 620A, 620B coating
710 first electrode main body
711 first connection electrode
720A, 720B second electrode main body
721A, 721B second connection electrode
900 controller
910 detector
920 heating controller
C1 circuit

1. A flavor inhaler comprising:
a heater comprising a plurality of heating elements and at least one first electrode, wherein the plurality of heating elements are stacked with the at least one first electrode interposed therebetween.

2. The flavor inhaler according to claim 1,
wherein the plurality of heating elements include a first heating element and a second heating element,
the first heating element, the second heating element, and the first electrode have respective planar shapes, and
the first heating element and the second heating element are disposed so as to face each other with the first electrode interposed therebetween.

3. The flavor inhaler according to claim 1, further comprising:
a second electrode stacked outside an outermost heating element out of the plurality of heating elements,
wherein at least one of the first electrode and the second electrode includes a planar supporting member having conductivity.

4. The flavor inhaler according to claim 3,
wherein the supporting member includes stainless steel.

5. The flavor inhaler according to claim 3, further comprising a connection electrode,
wherein, in at least one electrode out of the first electrode and the second electrode, the connection electrode is formed along a plane in which an adjacent heating element adjacent to the at least one electrode extends, and the connection electrode protrudes in a longitudinal direction of the adjacent heating element from a range in which the adjacent heating element extends.

6. The flavor inhaler according to claim 5,
wherein the connection electrode has a connection portion at an end surface thereof or near the end surface thereof to be connected to an outer portion, and an insulation treatment is applied to a surface of the connection electrode other than the connection portion.

7. The flavor inhaler according to claim 5,
wherein no electrode other than the connection electrode protrudes from the range in which the adjacent heating element extends along the plane in which the adjacent heating element extends.

8. The flavor inhaler according to claim 3,
wherein at least one electrode out of the first electrode and the second electrode includes a plurality of current-carrying regions, and
the plurality of current-carrying regions are disposed so as to respectively face a plurality of heating portions of the heating element adjacent to the at least one electrode.

9. The flavor inhaler according to claim 1,
wherein the first electrode includes a thermally insulative material.

10. The flavor inhaler according to claim 1, further comprising:
a heating controller configured to control a voltage or a current applied to each of the plurality of heating elements.

11. The flavor inhaler according to claim 10,
wherein the heating controller controls the voltage to heat a subset of the plurality of heating elements, and after that, heat at least a subset of the other heating elements.

12. The flavor inhaler according to claim 1,
wherein, the plurality of heating elements include a positive temperature coefficient element.

13. A flavor inhaling system comprising:
a consumer product having a flavor component; and
the flavor inhaler according to claim 1.

14. The flavor inhaling system according to claim 13,
wherein the consumer product includes a plurality of portions having identical or different flavor components disposed at positions respectively facing the plurality of heating elements when inhalation is performed.
